(19) United States
(12) Patent Application Publication
(10) Pub. No.: US 2003/0110086 A1
(43) Pub. Date: Jun. 12, 2003

(54) Electric-business method for customized merchandise

(76) Inventors: Benjamin Lin, Taipei City (TW); Chung-Chih Lin, Taipei (TW); Wen-Hao Hsu, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/005,101

(22) Filed: Dec. 7, 2001

(51) Int. Cl. G06F 17/60

(52) U.S. Cl. 705/26

(57) ABSTRACT

An electric-business method of customized merchandise comprises accepting a request of merchandise service from an exterior electric device. A plurality of items of merchandise is displayed according to the request of merchandise service, wherein the items are executed by a computer performing a plurality of functions of the merchandise. A request of item selection is accepted for selecting parts of the items. A price of the merchandise is evaluated dependent on the selected items. Then the merchandise is output to the exterior electric device. The request of merchandise service and outputted merchandise comprise a serial number related to the merchandise.

### BACKGROUND OF THE INVENTION

1. Field of the Invention

The invention relates to an electric-business method for merchandise, and more particularly to an electric-business method for customized merchandise. The method provides the customer with real-time ability to build customized merchandise on line.

2. Description of the Prior Art

Sales of products and services traditionally have been transacted by sales people or agents. More recently, sales of products and services, in particular high technology products, including software products, have been transacted by a combination of sales people and electronic delivery and/or payment systems. Consumers today increasingly expect immediate access to products, services and information, via telecommunications-, intranet-, Internet-, cable-, and satellite-based commerce systems or combinations thereof

Telecommunications technology including predictive dialers, automated call management systems and database management technology has enabled “teleservice” to become a more cost-effective way of reaching consumers. Inbound teleservice activity, often in a customer service application, is growing rapidly, placing demands on corporate staffing requirements to handle increased call loads while providing faster delivery of products, services, and information to the consumer.

However, due to the opening of electric business in a network, the encryption and authorization for transmitting and vending merchandise on line is extremely important. Furthermore, it is a challenge for electric-business vendors or providers to provide genuinely customized merchandise on line.

### SUMMARY OF THE INVENTION

It is a principal object of the present invention to provide an electric-business method for merchandise, which would be applied by an application service provider (ASP). The merchandise provides multitudes of functions that could be itemized, such that customers could select the specific items for the customized merchandise they want.

It is another object of the present invention to provide an electric-business method of customized merchandise through a specific serial number. Each item of the customized merchandise would be evaluated and paid by customers. The specific serial number is generated according to the selected items, then authorized and transmitted to the customers.

It is a further object of the present invention to provide an electric-business method for merchandise that a customer would like to upgrade. The customer needs to send a serial number belonging to the merchandise in use. The serial number comprises the information of the merchandise in use, which could enable the merchandise provider to keep track of the merchandise in demand.

In the present invention, an electric-business method of merchandise comprises providing the merchandise that has a plurality of items. These items can be executed by an electric device and thereafter display a plurality of functions of the merchandise. After the selection of the parts of the items, a selling price of the merchandise is evaluated according to the selected items. Furthermore, a request system could be communicated to a system of merchandise service through a serial number. The serial number comprises information related to the merchandise.

### BRIEF DESCRIPTION OF THE DRAWINGS

A better understanding of the invention may be derived by reading the following detailed description with reference to the accompanying drawings wherein:

FIG. 1 is a schematic diagram illustrating a preferred system in accordance with the present invention;

FIG. 2 is a schematic diagram illustrating a flow chart of the preferred system in accordance with the present invention;

FIG. 3A is a flow chart illustrating the main steps of “step 20” in FIG. 2 in accordance with the present invention;

FIG. 3B is a schematic diagram illustrating the serial number in accordance with the present invention;

FIG. 4A is a schematic diagram illustrating the main flow chart of “step 25” of FIG. 2 in accordance with the present invention;

FIG. 4B is a schematic diagram illustrating the encoding and decoding of the serial number in accordance with the present invention;

FIG. 5 is a schematic diagram illustrating the interface on an output display of “step 22” of FIG. 2 in accordance with the present invention;

FIG. 6 is a schematic diagram illustrating the interface on a display screen of “step 23” in FIG. 2 in accordance with the present invention; and

FIG. 7 is a flow chart illustrating the automatic-detection mechanism in accordance with the present invention.

### DESCRIPTION OF THE PREFERRED EMBODIMENT

While the invention is described in terms of a single preferred embodiment, those skilled in the art will recognize that many devices described below can be altered as well as other substitutions with same function and can be freely made without departing from the spirit and scope of the invention.

In the present invention, an electric-business method of customized merchandise comprises accepting a request of merchandise service from an exterior electric device. A plurality of items of merchandise is displayed according to the request of merchandise service, wherein the items are executed by a computer performing a plurality of functions of the merchandise. A request of item selection is accepted for selecting parts of the items. A price of the merchandise is evaluated dependent on the selected items. Then the merchandise is output to the exterior electric device. The requests of merchandise service and outputted merchandise comprise a serial number related to the merchandise.

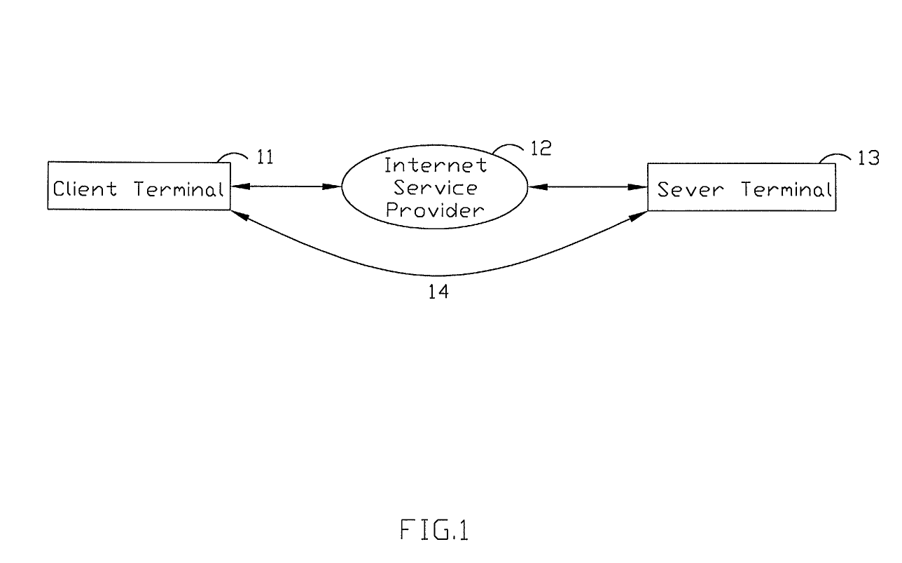

FIG. 1 is a schematic diagram illustrating a preferred system in accordance with the present invention. In a preferred embodiment shown in FIG. 1, a client terminal 11 could be a personal computer or any electric equipment that would execute any application programs and be connected to Internet or network. A server terminal 13 could be a server provided by an e-business or renter company. The client terminal 11 communicates with the server terminal 13 by any telecommunication line via wire telecom devices such as a wire telephone, modem, or a wireless telecom device such as a mobile phone or a personal digital assistant (PDA) connected to an Internet service provider 12 or network 14.

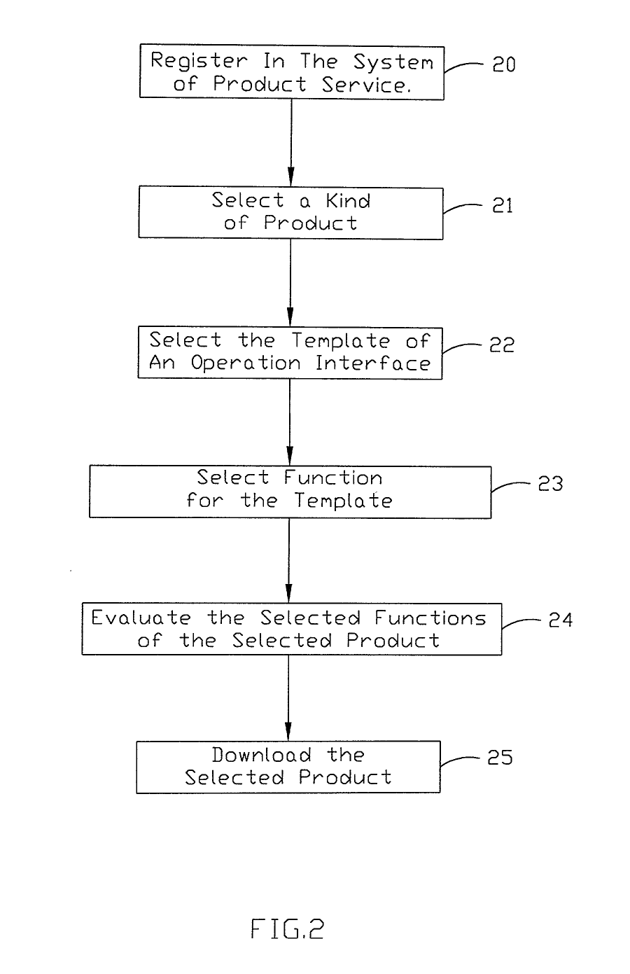

FIG. 2 is a schematic diagram illustrating a flow chart of the preferred system in accordance with the present invention. Connected to the merchandise service provider of the present invention through Internet service with a wired personal computer or wireless mobile phone, the user of the client terminal would register in the system of product service built in the server terminal (step 20). Next, the certified user would select various kinds of product listed in a product catalog provided by the system of product service (step 21). The product in the present invention is mainly computer-readable, computer-storable and computer-executable merchandise, such as a product of package software in the preferred embodiment.

Furthermore, one feature of the present invention is to develop a customized product, that the customer (or the user) would select the specific functions of the product by him or herself. Once the customer determines a selected product, the customization procedure for the selected product starts. First, the customer selects the template of an operation interface (step 22). In the present invention, the template of the operation interface is a communicated interface with a user when the user utilizes the selected product. For a product such as package software, in the preferred embodiment the template of the operation interface is one shown on a display when the product of package software is installed into a user's electric device.

Next, the customer selects various functions that would be built or included in the template of the operation interface for the selected product (step 23). The functions in the present invention represent what the customer could get. Specific effects shown under the environment built by the selected product through tools or objects provided by the selected product. For products such as package software, the customer selects various edit tools, such as a bold tool or a frame tool, or various management tools, such as utility of database, to accommodate the of edition or management of selected product. One feature of the present invention is to concretely itemize and evaluate the functions of the selected product, which allows the customer to personally select the functions. Furthermore, the customer pays the selected customized product dependent on the amount and complication of the selected functions. The price of the customized product would result in a reduced cost.

The customization procedure for the selected product is completed when the customer determines the specific functions, and then the selected customized product is evaluated by the system of product service (step 24). When the customer agrees to the price and the expiration of the selected customized product, the certification step of payment and identification is executed by the system of product service (step 25). Then the selected customized product is downloaded from the server terminal to the user's electric device (step 26).

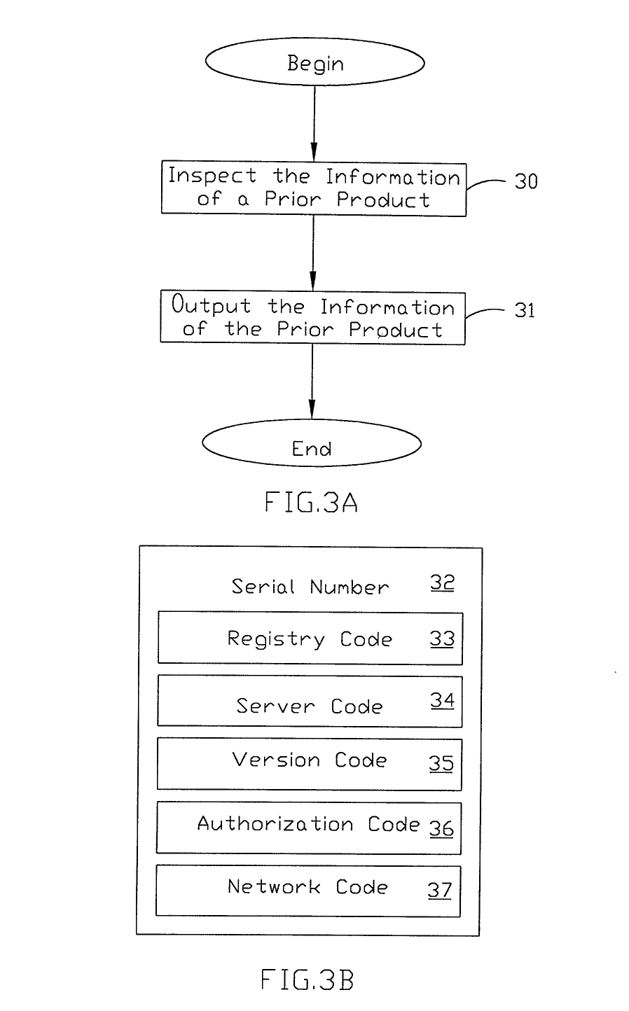

FIG. 3A is a flow chart illustrating the main steps of “step 20” in FIG. 2 in accordance with the present invention. Once a prior product preexists in the user's electric device, a serial number of the prior product needs to be outputted by the user and transmitted to the server terminal for the inspection of the prior product by the server terminal (step 30). The system of product service in the server terminal would output the information of the prior product according to the serial number decoded by the server terminal (step 31). Thus, the customer could select a similar product or functions of the same product with reference to the prior product in his or her own electric device.

FIG. 3B is a schematic diagram illustrating the serial number in accordance with the present invention. In the preferred embodiment, a serial number 32 consists of multitudes of bytes, which are encoded and decoded through the client terminal and the server terminal. The information in the serial number 32 includes a registry code 33, a server code of the server terminal 34, a version code 35, an authorization code 36, and network code 37. In the procedure of electric business related to the selected product, the registry code 33 represents the information of the selected product in communication with the user's electric device. The server code of the server terminal 34 represents the information of the server responsible for the procedure of the electric business.

Furthermore, one feature of the present invention, the version code 35 represents the information of the selected product. In the preferred embodiment, the information of the selected product consists of the version of the package software, kind, language, and so on. The functions provided by the selected product are enabled through the decoding of the version code 35 in the user's electric device (the client terminal). For example, the customer determines the specific functions of the selected product, pays for the customized selected product, and downloads the customized selected product. When the customized selected product is installed in the user's electric device, those selected specific functions are enabled through the version code 35, while other unselected functions in the customized selected product are disabled. When the customer selects and pays for the additional functions of the selected product next time, he or she could directly use the selected additional functions in his or her own computer through a renewed serial number authorized by the server terminal.

Furthermore, the authorization code 36 represents the expiration time of the selected product. When the selected product is installed in the user terminal and executed, the authorization code 36 is renewed according to the executed duration of the selected product. The residual time for the prior product could be added into the paid expiration time through the renewed authorization code 36 during the next electric business transaction. Furthermore, the network code 37 comprises of all the information of previous transactions of the electric business.

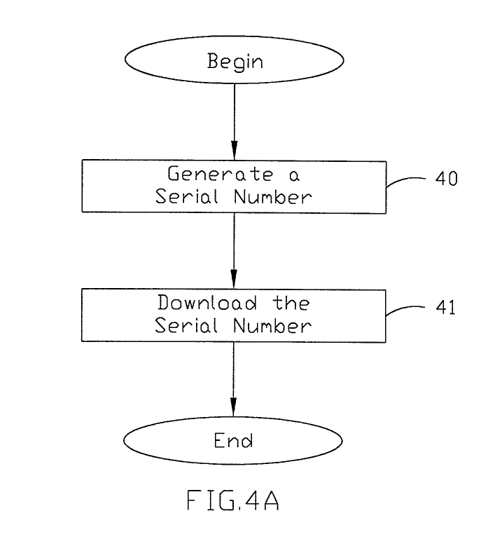

FIG. 4A is a schematic diagram illustrating the main flow chart of “step 25” of FIG. 2 in accordance with the present invention. After an evaluation procedure for the customized product is completed by the system of product service, a new serial number is generated for the customized product (step 40). When a same prior product preexists in the client terminal, the serial number is renewed, and the current information of the electric business and the information of the selected products are added into the prior serial number to generate a renewed serial number. Then the new or renewed serial number is included into the customized product and is downloaded into the user's electric device (step 41). On the other hand, the client terminal imports an authorization number comprising the information of the renew serial number to the user such that the user is authorized to use the customized product. Furthermore, once the user sets up and then starts the customized product in the client terminal, the authorization number is decoded for confirmation and the renewed serial number is changed according to the fee expiration of the customized product in the client terminal.

FIG. 4B is a schematic diagram illustrating the encoding and decoding of the serial number in accordance with the present invention. In the embodiment, the serial number comprises 16 bytes, but it is not limited in the present invention. A registry code 80, a server code 81 and a reserved code 82 are encoded to produce the first session 84. The “CRC” code 83 represents the checking code for the procedure of encoding or decoding. Next, the “CRC” code 83, the version code 85 and the network code 86 are added into the first session 84 for further encoding to produce the second session 87. Then the authorization code 88 is added into the second session 84 for another encoding to produce the 16-byte final serial number 89. The 16-byte final serial number 89 also needs to be decoded three times for acquiring all the information included in the 16-byte serial number 89.

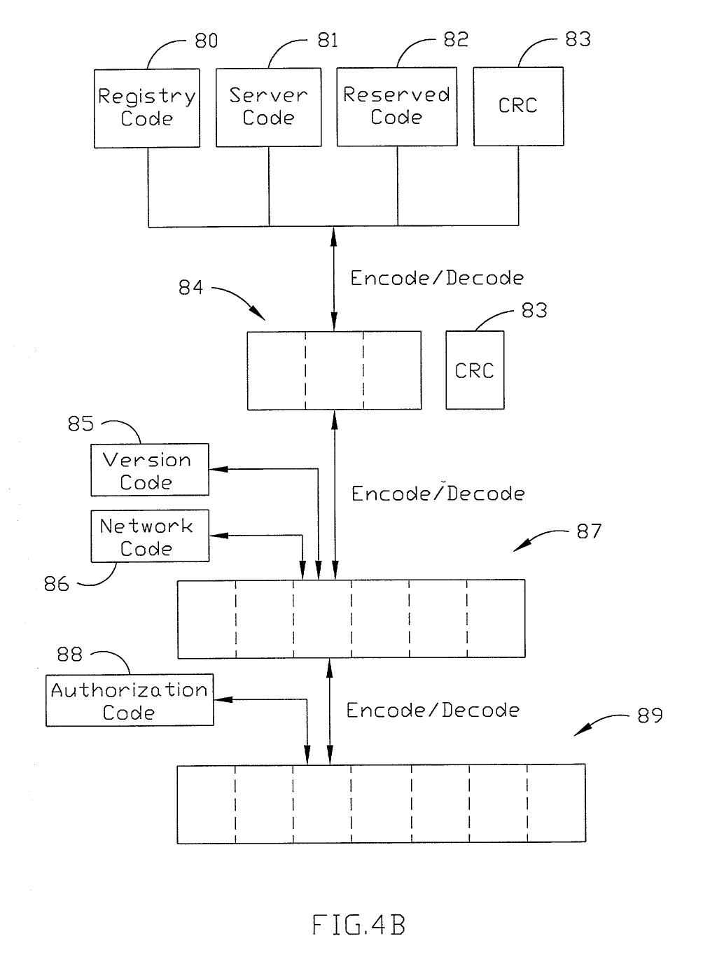

FIG. 5 is a schematic diagram illustrating the interface on an output display of “step 22” of FIG. 2 in accordance with the present invention. An interface of template selection 50 is introduced in accordance with the specific kind of product determined by the user. The interface of template selection 50 could be a sub window opened by the system of product service. For simplification, those general tools by any operational environment software aren't shown therein. There are various templates 51 in the interface of template selection 50. For the package software in the preferred embodiment, the template 41 comprises multitudes of operating zones, such as a tool bar 52, edit zone 53 or dialog zone 54, and so on. The customer could select the contents and functions in each operating zone. One advantage of the present invention is to provide the flexible selection for the template to the customer, so as to the customization of the selected product.

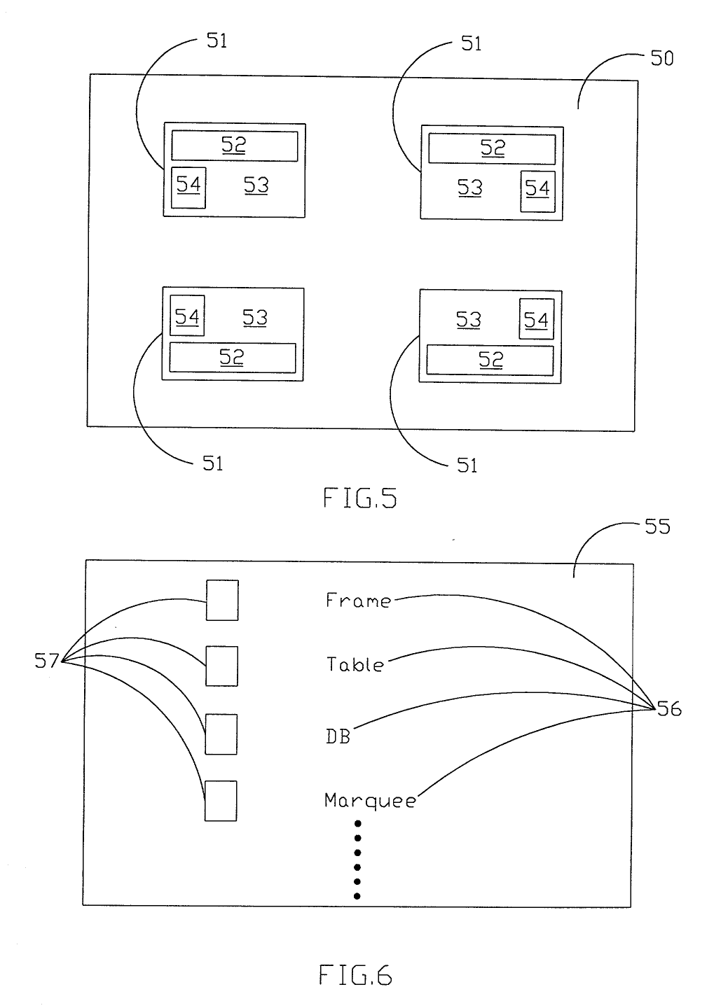

FIG. 6 is a schematic diagram illustrating the interface on a display screen of “step 23” in FIG. 2 in accordance with the present invention. Once the customer determines a template, he or she could select the contents and functions for the template. The system of product service would open a selection menu of function 55 for each operating zone. The selection menu of function 55 at least comprises multitudes of name of functions 56 and selection buttons 57. To be specific, there are other display zones included in the selection menu of function 55, such as a pup-up dialog. The customer could determine any function by selecting corresponding selection button 57 and add the selected function into the any operating zone.

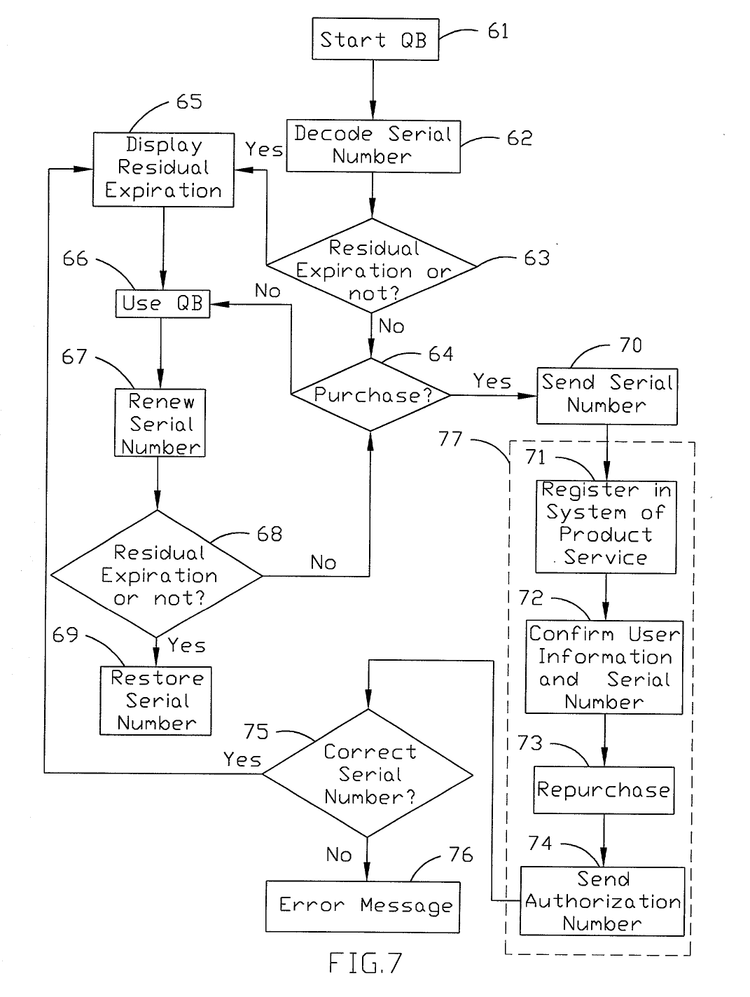

FIG. 7 is a flow chart illustrating the automatic-detection mechanism in accordance with the present invention. Shown in FIG. 7, dash boundary 77 comprises multitudes of steps executed by the server terminal, while other steps not included in the dash boundary 77 executed by the client terminal. In this embodiment, a preexisted product, such as package software named as “QB”, has been installed in the client terminal and a serial number has been registered in the client terminal. The serial number comprises all of information about “QB” and a user thereof. When the user starts QB (step 61) in the client terminal, QB first decodes and deciphers the serial number for acquiring the information of the preexisted product (step 62). On condition of QB with a fee expiration in the client terminal, a residual expiration of QB is acquired (step 63) and the user is informed the information of residual expiration (step 65). Thus, the user can user QB in the client terminal (step 66). During the execution of QB in the client terminal, the information of residual expiration is repeatedly renewed, restored in the serial number (step 67) and rechecked whether the total fee expiration is due or not (step 68). The serial number could be renewed and restored only on condition of the effectual fee expiration (step 69).

On the other hand, QB can automatically remind the user to on-line repurchase the new fee expiration if the prior fee expiration is due (step 64). Next, the serial number of QB preexisted in the client number needs to be sent to the system of product service (step 70) and registered in the system of product service (step 71). The user also needs to input the user's information and the serial number of preexisted QB for the confirmation by the system of product service (step 72). Next, the system of product service in the server terminal executes the deal process of the customized product with the user. When the user is authorized and confirmed to repurchase the renew QB or new fee expiration (step 73), the serial number of the preexisted QB would be changed and renewed by the server terminal according to the deal this time. The repurchased QB comprising the new serial number would be sent to the client terminal through Internet, and authorization number comprising the information of the new serial number would be sent through e-mail from the server terminal to authorize the user (step 74). The new serial number would be confirmed by the QB in the client terminal after the user uses the repurchased QB (step 75). An error message would remind the user in the client terminal if the user inputs the wrong authorization number (step 76).

While this invention has been described with reference to illustrative embodiments, this description is not intended or to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A electric-business method of a merchandise, said method comprising:
providing said merchandise, said merchandise having a plurality of items that are executed by an electric device and thereafter display a plurality of functions of said merchandise;
selecting the parts of said items; and
evaluating a selling price of said merchandise according to said selected items.

2. The electric-business method of claim 1 further comprising:
communicating a request system to a system of merchandise service, said system of merchandise at least storing a plurality of computer-executive programs corresponding to said merchandise and said items; and
outputting said merchandise to said request system wherein said merchandise comprises said selected items.

3. The electric-business method of claim 2, wherein said request system transmits a serial number comprising a plurality of bytes to said system of merchandise.

4. The electric-business method of claim 3, wherein said serial number comprises:
a server code related to said request system;
a version code related to a version information of said merchandise preexisted in said request system; and
an authorization code related to an expiration time of said merchandise preexisted in said request system, said authorization renewed according to an execution time by said request system.

5. The electric-business method of claim 3, wherein said serial number is changed after the evaluating step.

6. The electric-business method of claim 2, wherein said communicating step is implemented through a wire network.

7. The electric-business method of claim 2, wherein said communicating step is implemented through a wireless network.

8. A electric-business method of a software merchandise, said method comprising:
communicating a first electric device to a second electric device;
providing said software merchandise by said second electric device, said software merchandise displaying a plurality of function through a plurality of items executed by a computer;
selecting parts of said items by said first electric device;
building a customized software merchandise according to said selected items;
evaluating a price of said customized software merchandise; and
outputting said customized software merchandise to said first device.

9. The electric-business method of claim 8 further comprising executing a payment procedure according to said price between said first electric device and said second electric device.

10. The electric-business method of claim 8, wherein said communicating step comprises transmitting a serial number between said first electric device and said second electric device.

11. The electric-business method of claim 8, wherein said outputting step comprises a serial number included in said customized software merchandise.

12. The electric-business method of claim 11 , wherein said serial number comprises:
a registry code related to communication of said first electric device and said second electric device; and
an authorization code related to an expiration time of said customized software merchandise.

13. The electric-business method of claim 12, wherein said authorization code is changed dependent on an execution time on said first electric device.

14. The electric-business method of claim 8, wherein said second electric device comprise at least a server belonging to an application service provider.

15. A electric-business method of a customized merchandise, said method comprising:
accepting a request of merchandise service from an exterior electric device;
displaying a plurality of items of a merchandise according to said request of merchandise service, said items executed by a computer performing a plurality of functions of said merchandise;
accepting a request of item selection, said request of item selection for selecting parts of said items;
calculating a price of said merchandise, said price dependent on said selected items; and
outputting said merchandise to said exterior electric device.

16. The electric-business method of claim 15 further comprising:
accepting a request of payment from said exterior electric device;
inspecting an identification from said exterior electric device;
generating a serial number of said merchandise according to said merchandise, said selected items and said request of merchandise service; and
transmitting said serial number to said exterior electric device.

17. The electric-business method of claim 15, wherein said request of merchandise service comprising a utility information related to said merchandise that is preexisted in said exterior electric device.

18. The electric-business method of claim 15, wherein said serial number comprises an expiration time of said merchandise executed by said exterior electric device.

19. The electric-business method of claim 15, wherein said request of merchandise service is transmitted through a wire network.

20. The electric-business method of claim 15, wherein said merchandise comprises a product of package software.
